(19) United States
(12) Patent Application Publication
(10) Pub. No.: US 2009/0084247 A1
(43) Pub. Date: Apr. 2, 2009

(54) Filter tip drum stick

(76) Inventor: David Chappell Rundle, Campbellville (CA)

Correspondence Address: David C. Rundle, 2291 Britannia Rd RR#3, Campbellville, ON, LOP IBO, CA

(21) Appl. No.: 11/906,043

(22) Filed: Oct. 1, 2007

(51) Int. Cl. G10D 13/02

(52) U.S. Cl. 84/422.4

(57) ABSTRACT

A stick type drum stick is disclosed which includes drum stick design featuring a hole drilled longitudinally in the playing striking end. The primary purpose is to accommodate a rod. The rod is inserted and glued into the hole of the tip. The rod can be cut to a desired length to suit its flex and resilient nature. Suitable material for the rod include nylon or delrin, PVC, ABS, polypropylene or polycarbonate. The result of combining these materials in this format produces a filter tip drum stick.

### BACKGROUND OF THE INVENTION

1. Field of Invention

The present invention relates to drumsticks and, more particularly, to a unique wooden stick type drumstick with improved percussive characteristics.

2. Description of the Prior Art

In the prior art there have been three types of drum sticks. The brush type which typically produces a sweeping sound and the stick type which produce a much stronger or more percussive sound. In the prior art stick type drum sticks were made of elongated round, generally cylindrical solid wood members that were tapered near one end. This end typically was in the shape of a ball-like head which was used to beat on the drum.

The brush type drumsticks were usually made up of a plurality of metal filaments secured to a handle. One improved embodiment of a brush type drum stick is shown in U.S. Pat. No. 4,200,026. That invention involves the use of a plurality of elongated plastic strands which are arranged in a tight bundle which is fixed at one end as by molding or fusing to form a handle. The plastic strands are free to spread out at the other end to achieve the brush sound when used. That drumstick although an improvement over prior art brush sticks offers only limited use as a percussive stick owing to its basically soft and flexible nature.

In U.S. Pat. No. 4,535,671, that patent provides certain unique playing characteristics suitable for certain applications. By means of this drumstick certain percussive resonance and tonal qualities are met. The drumstick of this invention includes a bundle, substantially straight wooden rods, which are preferably round hardwood rods such as dowels. The bundle is assembled and bound or banded tightly together, as by a rigid plastic tape. In this drumstick design a band is placed at a location relatively close to the playing or beating end. The rods at the handle end of the bundle are also retained tightly together. A sleeve or overlay retainer may then be applied over the drumstick at the opposite end to form the handle. The combination of the binding of the rods as such yields a stick type drumstick, which has specific percussive strength, yet it is slightly flexible so that the combination including the interaction of the wooden rods among themselves when a drum is struck yields its tonal qualities.

A third drumstick design under U.S. Pat. No. 7,084,339 is registered under this applicants name and utilizes a central foam core surrounded by multiple rods. These materials are held together in a round bundle using tape and shrink tubing. The playing characteristics include an increase bounce effect, the foam core aids in protecting the small outer rods at force of impact.

The drumstick design as follows, includes a traditional drum stick with additional attributes to enrich its dynamic range. This is accomplished by drilling longitudinally into the tip or striking end of the drum stick a small hole. A rod is glued into the hole and cut to a suitable length. The resulting design increases the rebound and increases the dynamic range available.

### SUMMARY OF THE INVENTION

The drumstick of the present invention includes traditional drumstick design featuring a hole drilled longitudinally into the tip at the playing striking end, hereafter referred to as a ‘tip’. A traditional drumstick design is traditionally a wooden dowel of reasonably straightness that has a gradual taper at one end which forms into a bead at the striking or playing end. The primary purpose of such a ‘tip’ design is to accommodate a rod. The rod is inserted and glued into the hole of the tip. The rod can be cut to a desired length to suit its flex and resilient nature. Suitable material for the rods include nylon or delrin, PVC, ABS, polypropylene or polycarbonate. The result of combining the rod material and the traditional drumstick in this format produces a filter tip drum stick. A filter tip drum stick invention will provide additional rebound and bounce. It will increase the dynamic range available in one drumstick to the percussionist. By playing the drumstick with a normal angle of attack to a given playing surface, the drumstick responds and plays like a normal drumstick. By increasing the angle of attack to the playing surface the drummer percussionist can start to filter out the sound of the normal tip contact sound. This is accomplished as the rod comes in to contact with the playing surface reducing the contact of the tip to the playing surface. Initially, if the player plays with a slight increase in the angle of attack, the rods contact the playing surface and increase its bounce response. By increasing the angle of attack and reducing the force of play the drummer can eliminate the sound created from the tip contacting the playing surface and slowly introduce the sound of the rod striking the playing surface. The rod is smaller in diameter size and has less mass than the wood tip of the drumstick therefore the rod will produce considerably less volume. The rod example such as nylon is very resilient and is highly responsive to bounce and creates a soft sound of cymbals and drums. This combination of materials in this format dramatically increases the dynamic range available to the drummer percussionist without changing drumsticks mid-play or compromising the physical intensity in the approach to the musical composition. During musical passages that require louder volume and more physical force with rapid changes to extreme softness at medium and fast tempos, the percussionist can simply change the angle if attack and accomplish these tasks without changing to drumsticks.

### BRIEF DESCRIPTION OF THE DRAWINGS

In the drawings wherein like numerals are used to depict like parts throughout the same:

FIG. 1 is a side view of the traditional drum stick with hole drilled;

FIG. 2 is a side view depicting the embodiment of the drumstick of the invention;

FIG. 2A is an enlarged view starting at line 2A of FIG. 2

FIG. 3 is a side view of an alternate drum stick with hole drilled;

FIG. 4 is a side view depicting the embodiment of the alternate drumstick;

FIG. 4A is an enlarged view starting at line 4A of FIG. 4

### DESCRIPTION OF THE PREFERRED EMBODIMENTS

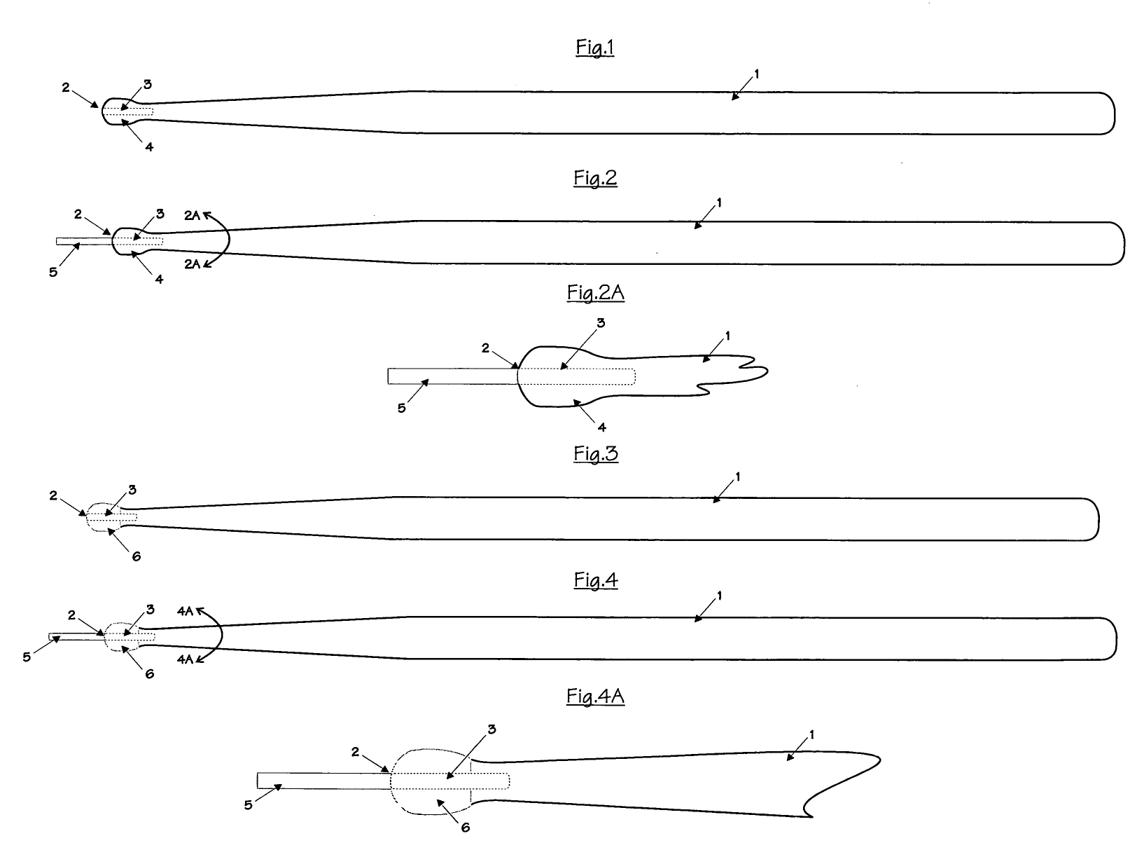

FIG. 1 depicts a traditional drum stick with hole 3 drilled at 2. It will be appreciated that the individual rod 5 depicted in FIG. 2 and FIG. 2A of the drumstick invention may be a synthetic material such as nylon or delrin, polypropylene, PVC or ABS plastic which has the required degree of stiffness and resilience desired. The rod 5 is depicted in the cross section 2A is glued into the pre-drilled hole 3 at the end solid wood tip 4 in FIG. 2 to form a complete filter tip drumstick as depicted in FIG. 2. An overall length of a traditional drum stick is usually 16 inches, the combined components is approximately 16.5 inches to 18 inches. The length and diameter size of rod may vary depending of the flexibility and resilient nature inherent in the material and maybe cut after the rod has been inserted and glued into the hole at 2. The depth of the hole 3 in FIG. 2 will be approximately 4 times the diameter of the rod 5 but may vary according to the width and length of the tip available on the drumstick. If the shaft is of sufficient diameter, the hole can be drilled deeper into the drumstick. The diameter of the rod 5 will determine the hole 3 size and depth necessary to secure the rod firmly in position. FIG. 3 depicts a traditional drum stick fitted with a ‘nylon tip’ 6, the hole 3 is drilled at 2. FIG. 4 depicts the drumstick in FIG. 3 with the rod 5 fitted in the hole 3 at 2. FIG. 4A provides and larger view of the tip area.

The embodiments of the invention in which an exclusive property or right is claimed are defined as follows;

1. A stick type drumstick comprising: a traditional drumstick in to which a synthetic rod is inserted and glued securely into a pre drilled hole at the playing tip or striking end of the said traditional drumstick.

2. The individual rod in claim 1 may be a material of a synthetic nature.

3. The pre drilled hole in claim 1 may vary in diameter and depth.

4. The individual rod of claim 3 wherein the diameter of the said individual rod may vary in diameter size.

5. The individual rod of the drumstick in claim 7 wherein said synthetic material is one selected from the group consisting of nylon, delrin, polypropylene, ABS or PVC.
